(19) United States
(12) Patent Application Publication
(10) Pub. No.: US 2006/0206403 A1
(43) Pub. Date: Sep. 14, 2006

(54) System for anonymously purchasing goods and services over the Internet

(75) Inventors: Geoffrey H. Gill, Warwick, RI (US); Phillip Klein, Barrington, RI (US)

Correspondence Address: ST. ONGE STEWARD JOHNSTON & REENS, LLC, 986 BEDFORD STREET, STAMFORD, CT, 06905-5619, US

(73) Assignee: Geoffrey H. Gill

(21) Appl. No.: 11/436,753

(22) Filed: May 18, 2006

Related U.S. Application Data
(63) Continuation of application No. 09/515,724, filed on Feb. 29, 2000.

(51) Int. Cl. G06Q 40/00

(52) U.S. Cl. 705/35

(57) ABSTRACT

A system for anonymously purchasing goods and services over the Internet comprising customer, issuer, merchant and financial institution computers all linked to a communications system, a money code, and a plurality of software. A money amount is received from a customer and a money code is assigned an associated money value. The financial institution computer receives and stores the money code and associated money value. The customer transmits an order and the money code to a merchant. The merchant receives the order and money code and determines a money amount due for the order. The amount due and the money code are transmitted to the financial institution. The financial institution compares the money amount due to the associated money value, and notifies the merchant of fund availability.

### CROSS-REFERENCE TO RELATED APPLICATIONS

This application is a continuation of U.S. patent application Ser. No. 09/515,724 filed Feb. 29, 2000.

### FIELD OF THE INVENTION

This invention relates to a system for anonymously purchasing goods and services over the Internet.

### BACKGROUND OF THE INVENTION

Internet commerce has become an increasing component of the consumer market. New Internet websites offering goods and services for sale are appearing at a remarkable rate. These websites offer a diverse variety of goods and services ranging from automobiles to stock trading to dating services. The availability of nearly every conceivable good or service over the Internet has fueled the expansion of Internet commerce. While the number of consumers drawn to the convenience of shopping at home on their computers grows, many consumers are weary of submitting financial and identification information over the Internet. Many feel that the current security measures offered by Internet merchants are insufficient to protect their financial information, namely their credit card information. While encryption and other methods, such as Secure Sockets Layer (SSL) or Secure Hypertext Transfer Protocol (S-HTTP) offered by Internet services, have greatly improved the security of transactions over the Internet, many consumers remain skeptical.

Furthermore, many consumers are concerned that the information regarding their purchasing habits and choices is also at risk. Many websites sell off their sales information to consumer research agencies and other companies. This concern is heightened in light of the multiple technologies available to website operators, such as cookies, for tracking and following consumers around the Internet and collecting information as to what and where they purchase items. As such, there is very little anonymity in purchasing goods and services over the Internet. While new technologies are evolving to defeat such tracking measures, such as cookie filtering utilities, there is a growing desire in consumers for the anonymity offered by cash transactions in the traditional merchant setting.

What is desired, therefore, is a system for anonymously purchasing goods and services over the Internet. Providing a system that limits a customer's exposure to financial loss when making purchases over the Internet is also desired.

### SUMMARY OF THE INVENTION

Accordingly it is an object of invention to provide a system for anonymously purchasing goods and services over the Internet.

Another object of the invention is to provide a system for generating a money code for use in purchasing goods and services over the Internet that is not traceable to the customer.

These and other objects of the invention are achieved by provision of a system for anonymously purchasing goods and services over the Internet comprising customer, issuer, merchant, and financial institution computers all linked to a communications system, a money code, and a plurality of software. Software executing on the issuer computer receives the money code and a money amount from a customer, assigns an associated money value to the money code based on the money amount received from the customer, and transmits the money code and associated money value to the financial institution computer over the communications system. Software executing on the financial institution computer receives the money code and associated money value transmitted by the issuer computer and stores the money code and associated money value. Software executing on the customer computer transmits an order and the money code to the merchant computer over the communications system. Software executing on the merchant computer receives the order and money code from the customer computer, determines a money amount due for the order, and transfers the money code and money amount due to the financial institution computer over the communications system. Software executing on the financial institution computer receives the money code and money amount due from the merchant computer, compares the money amount due to the associated money value, and notifies the merchant computer of fund availability.

Preferably, the communications system is the Internet and the system further comprises software executing on said merchant computer for operating and maintaining an Internet website, accessible by the customer, for facilitating commercial transactions between the customer and the merchant. The system also preferably includes software executing on the customer computer for generating a personal identification code of the customer's choice and requesting the personal identification code from the customer before transmitting the money code to the merchant computer over the communications link. Also, the system preferably includes software executing on the customer computer for encrypting the money code using the personal identification code to increase security of the system. The system may also include software executing on the customer and financial institution computers for deriving a plurality of sub-codes corresponding to the money amount presented by the customer to the issuer to further increase the security and anonymity of the system.

### BRIEF DESCRIPTION OF THE DRAWINGS

FIG. 1 is a schematic of a system for anonymously purchasing goods and services over the Internet in accordance with the invention.

FIG. 2 is a schematic of an embodiment of the money code generation and valuation process of the system for anonymously purchasing goods and services over the Internet of FIG. 1.

FIG. 3 is a schematic of another embodiment of the money code generation and valuation process of the system for anonymously purchasing goods and services over the Internet of FIG. 1.

FIG. 4 is a schematic of another embodiment of the money code generation and valuation process of the system for anonymously purchasing goods and services over the Internet of FIG. 1.

FIG. 5 is a schematic of another embodiment of the money code generation and valuation process of the system for anonymously purchasing goods and services over the Internet of FIG. 1.

FIG. 6 is a schematic of an embodiment of the money code submission and validation process of the system for anonymously purchasing goods and services over the Internet of FIG. 1.

FIG. 7 is a schematic of another embodiment of the money code submission and validation process of the system for anonymously purchasing goods and services over the Internet of FIG. 1.

FIG. 8 is a schematic of another embodiment of the money code submission and validation process of the system for anonymously purchasing goods and services over the Internet of FIG. 1.

FIG. 9 is a schematic of another embodiment of the money code generation and valuation process of the system for anonymously purchasing goods and services over the Internet of FIG. 1.

FIG. 10 is a schematic of an embodiment of the money code submission and validation process of the system for anonymously purchasing goods and services over the Internet of FIG. 1.

### DETAILED DESCRIPTION OF THE INVENTION

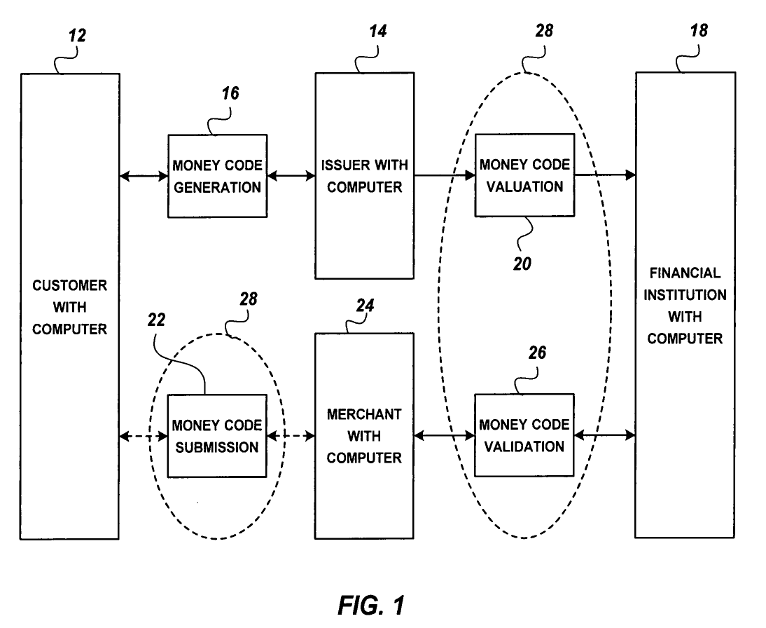

FIG. 1 depicts a system 10 for anonymously purchasing goods and services over the Internet in accordance with the invention. A customer 12, in conjunction with an issuer 14, generates a money code 16 corresponding to a certain money value. The money code is then transferred from the issuer 14 to a financial institution 18 and stored at the financial institution 18. The financial institution 18 can be any entity capable of receiving and storing the money codes 16 and any other associated information which may be submitted. The financial institution 18 must also be capable of receiving and processing requests for funds from merchants 24. For example, the financial institution may be a bank, credit card company, or other corporate entity with the above capabilities, such as a major department store.

By submitting the money code to the financial institution, the money code is valuated 20 and can be used in subsequent transactions. Once the money code is generated 16 and valuated 20, the customer 12 may submit the money code 22 to a merchant 24 to purchase goods and services. The merchant 24 validates the money code 26 by communicating with the financial institution 18 to ensure the money code is backed by sufficient funds. Preferably, all the parties are in communication with each other using computers over an appropriate communications system 28. For example, the computers may communicate modem-to-modem or via a hard-wire connection. Preferably, the computers include Internet connections and communicate directly over an Internet link.

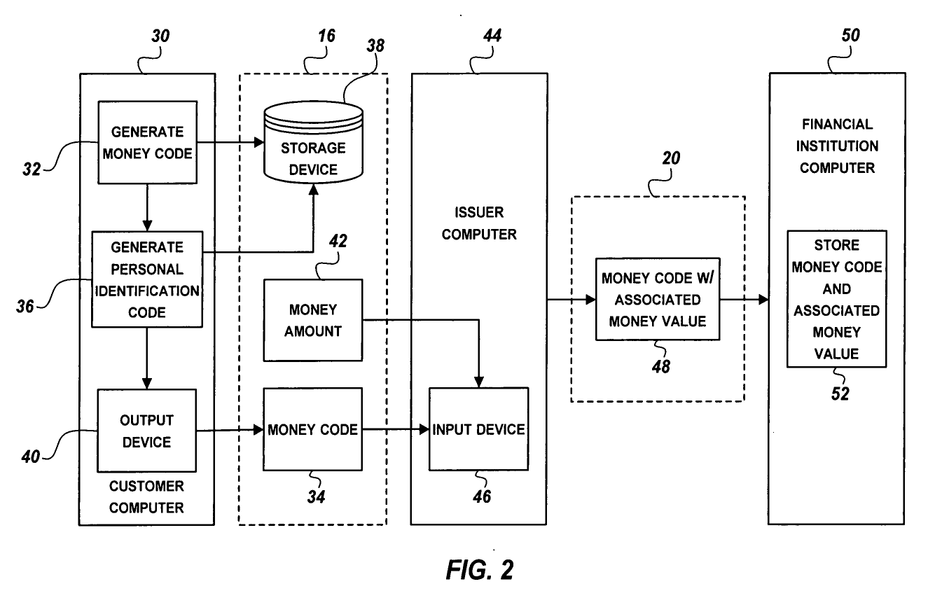

Referring to FIG. 2, an embodiment of the money code generation 16 and valuation 20 processes of the system 10 for anonymously purchasing goods and services over the Internet is shown. Software executing on the customer's computer 30 generates a money code 32. The money code 34 generally consists of a series of alpha-numeric characters or a computer-readable code, such as a bar code or magnetic imprint. Preferably, the software generates a random money code, but the customer 12 may generate a personalized money code and enter it into their computer 30. The software on the customer computer 30 may also generate or request a personal identification code 36 from the customer 12 to control later use of the money code 34. Upon successful generation of the money code 32, the software stores the money code 34 and associated personal identification code 36, if created, in a storage device 38. The storage device 38 may be any available storage means, such as floppy disks, hard drives, writable CD-ROM, random access memory, etc. The computer 30 then conveys the money code 34 to the customer 12 via an output device 40 such as a computer screen, printer, disk drive, magnetic encoder, etc. It is important to note that the money code 34 contains no identification data related to the customer 12.

Upon receipt of the money code 34, the customer 12 may present the money code 34 along with a money amount 42 to an issuer 14. The issuer 14 may be any establishment linked into the communications system 28. The issuer 12 enters the money code 34 and presented money amount 42 into the issuer's computer 44 using an input device 46. The input device 46 can vary depending on the form of money code 34. For example, the input device 46 may be a bar code reader if the money code 34 is in bar code form or it may be a keyboard if the money code 34 is in alpha-numeric form. Once entered into the issuer's computer 44, software executing on the computer 44 transmits the money code and associated money value 48 to the financial institution 18 over the communications system 28. Upon receipt by the financial institution 18, software executing on the financial institution's computer 50 stores the received information 52, preferably in a database containing a plurality of money codes and associated money values.

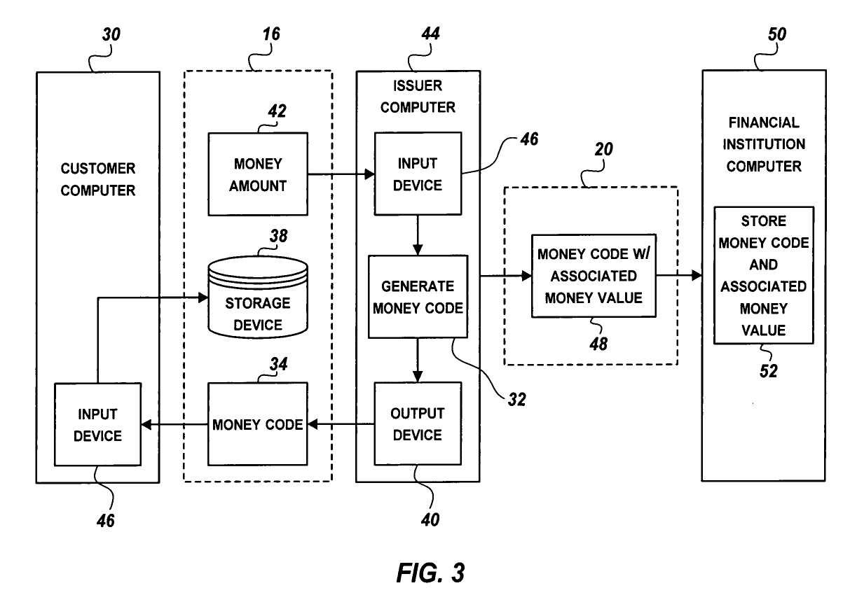

Alternatively, as shown in FIG. 3, instead of generating a money code 32 on the customer's computer 30, the customer 12 may receive a money code 34 from the issuer 14 upon payment of money 42. In this embodiment, the issuer 14 enters in a money amount 42 presented by the customer 12 and software executing on the issuer's computer 44 generates a money code 64 and conveys the money code 34 to the customer 12 through an output device 66. As above, the output device 66 may be of any form such as video screen, printer, disk drive, etc. The software also transfers the money code and associated money value 48 over the communications system 28 to the financial institution 18 for storage 52 and later use in the validation process 26. The customer 12 must then enter the money code 34 onto their computer 30 for storage and later retrieval and use. In this embodiment, the output device 66 used by the issuer 14 can be more advanced. For example, the issuer 14 could imprint the money code 34 on a magnetic strip on a card that is given to the customer 12. Thus, the customer 12 could reuse the card at a later date when the customer 12 needs to replenish the available funds behind the money code 34.

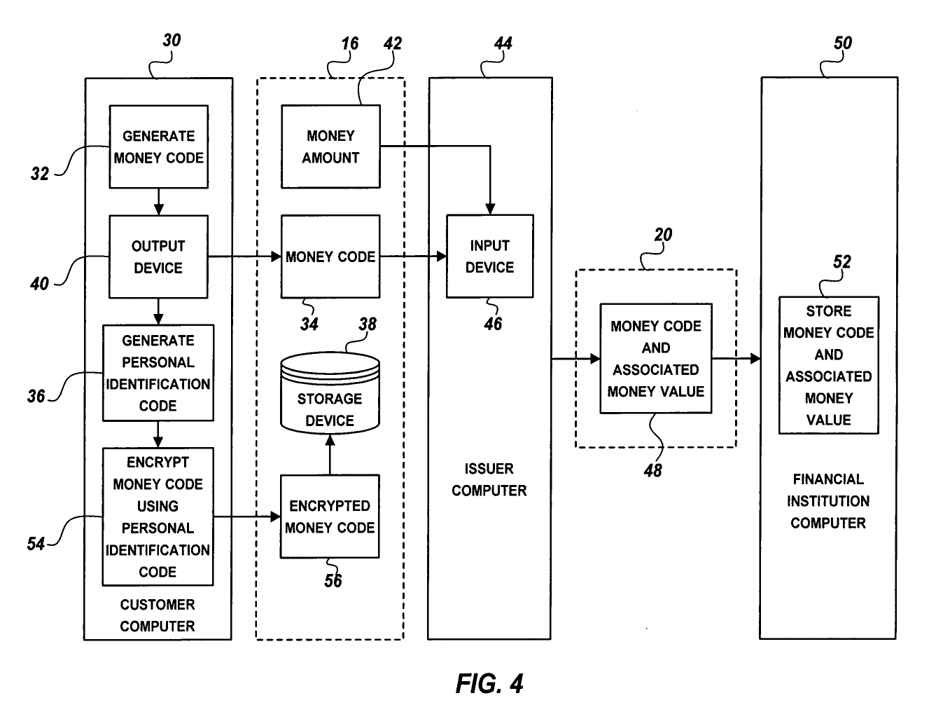

To improve the security of the system 10, the money code 34 may be encrypted before it is saved to the storage device 38 of the customer computer 30, as shown in FIG. 4. In this embodiment, upon generation of the money code 32, the customer computer 30 presents the money code 34 to the customer 12 through the output device 40 for later presentation to an issuer 14 in order to valuate 20 the money code 34, as described above. The customer 12 then selects a personal identification code 36. Software executing on the computer 30 uses the selected personal identification code to encrypt the money code 54 and stores the encrypted money code 56 on the storage device 38 for later access and use by the customer 12. Thus, the actual money code 34 is not stored within the computer 30, where a third party could possibly retrieve and use it without permission. The only money code on the computer is the encrypted money code 56, which can only be decrypted by providing the associated personal identification code.

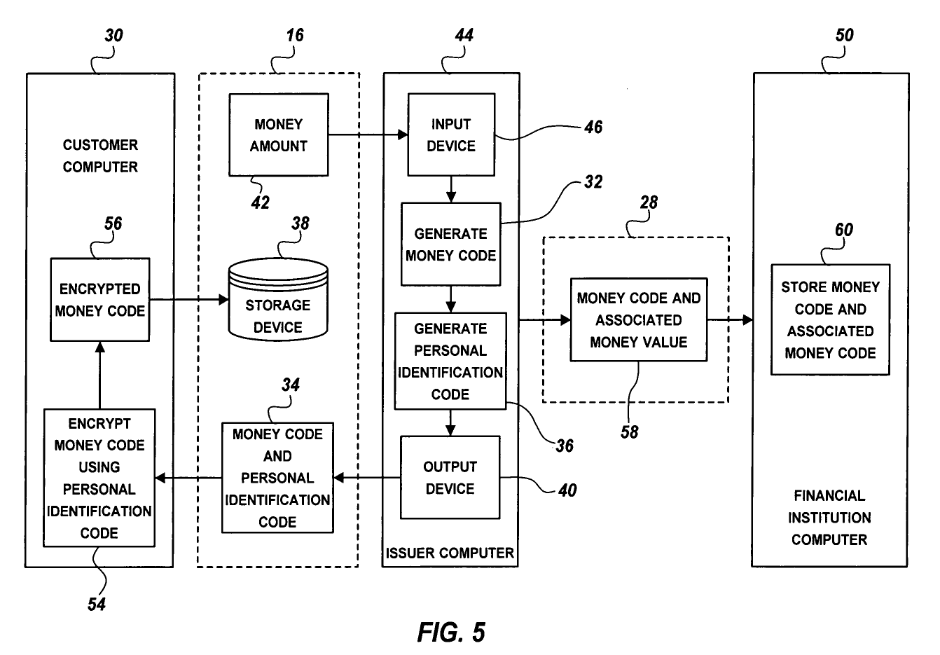

The encryption feature can also be used when the money code 34 is generated 32 by the issuer 14, as shown in FIG. 5. Upon presentation of a money amount 42 and entry of the money amount 42 into the issuer computer 44 via an input device 46, software executing on the issuer computer 44 generates a random money code 32 and either allows the user to select a personal identification code or generates one for the customer 36. The issuer computer 44 then transmits 58 the money code and associated money value over the communications system 28 to the financial institution computer 50 for storage 60. The customer 12 is then presented with the money code and personal identification code via an output device 40, which the customer 12 can enter into the customer computer 30 for encryption and storage as described above. Alternatively, rather than selecting a personal identification code at the issuer 14 location, the customer 12 may receive only a money code 34 from the issuer 14 and later select a personal identification code on the customer computer 30.

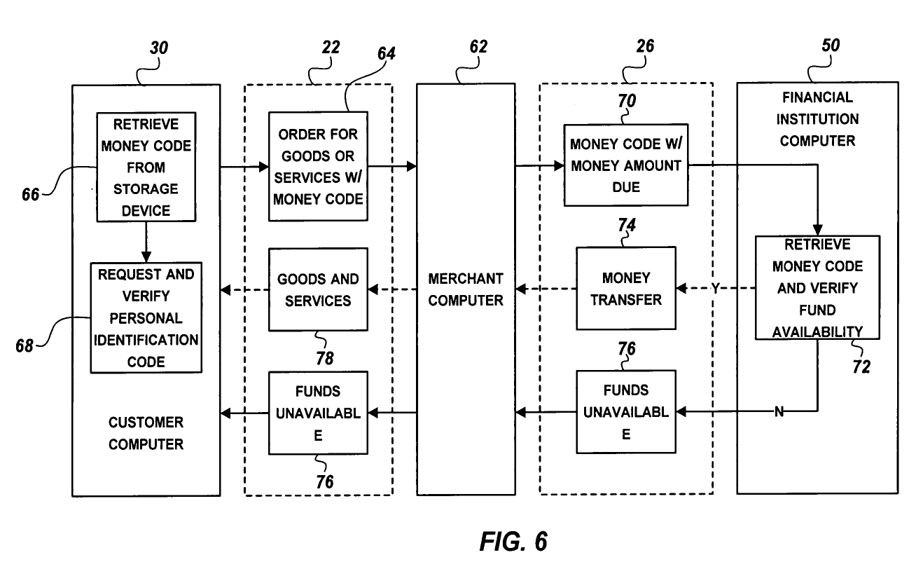

FIG. 6 depicts an embodiment of the money code submission 22 and validation 26 processes of the system 10 for anonymously purchasing goods and services over the Internet. The customer 12 uses their computer 30 to access a merchant computer 62 in order to purchase a good or service. Preferably, the merchant computer 62 contains software executing on it for operating and maintaining an Internet website for conducting commerce over the Internet that is accessible by the customer 12 using commercially available web browsing technology. Upon gaining access to the merchant computer 62, the customer 12 may submit an order 64 for goods and services including a money code 34 to the merchant computer 62. This is achieved by software on the customer computer 30 retrieving the money code from the storage device 66 and transmitting the money code 34 to the merchant computer 62 over the communications system 28. Preferably, the software executing on the customer computer 30 requests the customer 12 to enter a personal identification code and verifies it 68 before transmitting the money code 34. This ensures that only the customer 12 may use the money code 34.

Software executing on the merchant computer 62 receives the order 64 and money code 34 from the customer computer 30 and processes the order 64 to determine an amount due 70. The software then transfers the money code 34 and the amount due 70 to the financial institution computer 50 over the communications system 28 to ensure that the submitted money code 34 is backed by sufficient funds to cover the amount due 70. Software executing on the financial institution computer 50 receives the money code and amount due 70 from the merchant computer 62 and retrieves the corresponding money code and associated money value 48. The software then compares the amount due 70 with the associated dollar amount 48 to determine the availability of funds 72. If the amount due 70 is less than or equal to the associated money value of the money code 48, the financial institution 18 approves the fund transfer and transfers 74 the dollar amount due to the merchant 24. The fund transfer can be accomplished by an account-to-account electronic fund transfer or the financial institution 18 can generate and deliver a check for the requested amount to the merchant 24. The merchant 24 may then provide the customer 12 with the requested goods or services 78. If sufficient funds are not available, the merchant 24 is notified 76 of the situation and the merchant 24 may proceed with the sales transaction with the customer 12 as deemed appropriate.

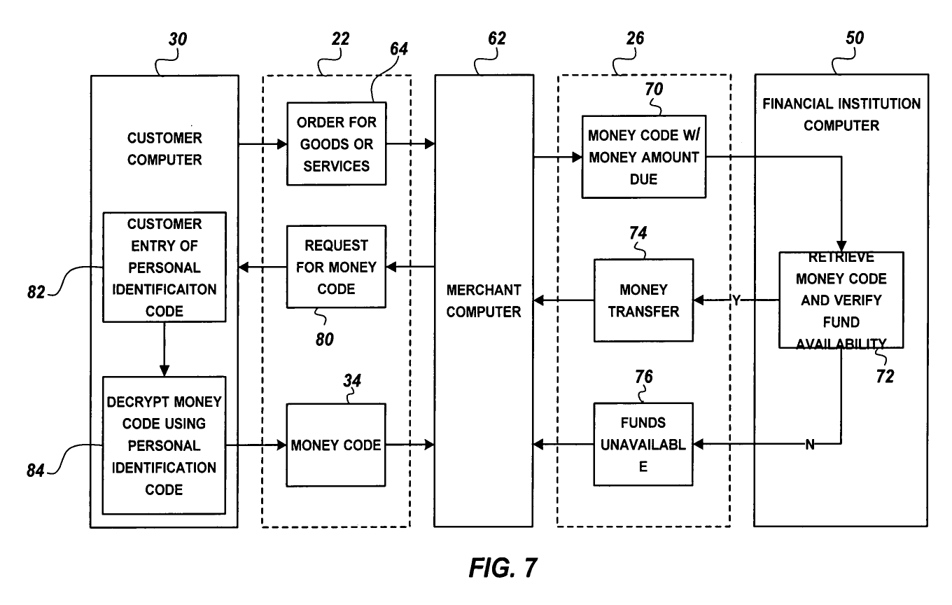

The money code submission 22 and validation 26 processes may also include the encryption feature described above. In this embodiment, as shown in FIG. 7, the money code submission process 22 includes the decryption of the encrypted money code 56. Upon gaining access to the merchant computer 62, the customer may submit an order 64 for goods or services. Software executing on the merchant computer 62 receives the order 64 and requests 80 the money code 34 from the customer 12. Software executing on the customer computer 30 then requests the customer 12 to enter 82 the personal identification code associated with the money code 34. The software then retrieves the encrypted money code 56 from the storage device 38, decrypts the money code using the personal identification code 84 provided by the customer 12, and transmits the decrypted money code 34 to the merchant computer 44 over the communications system 28. The merchant computer 44 then validates 26 the money code 34 as above. This embodiment presumes the money code 34 has been generated and encrypted on the customer computer 30 as described above.

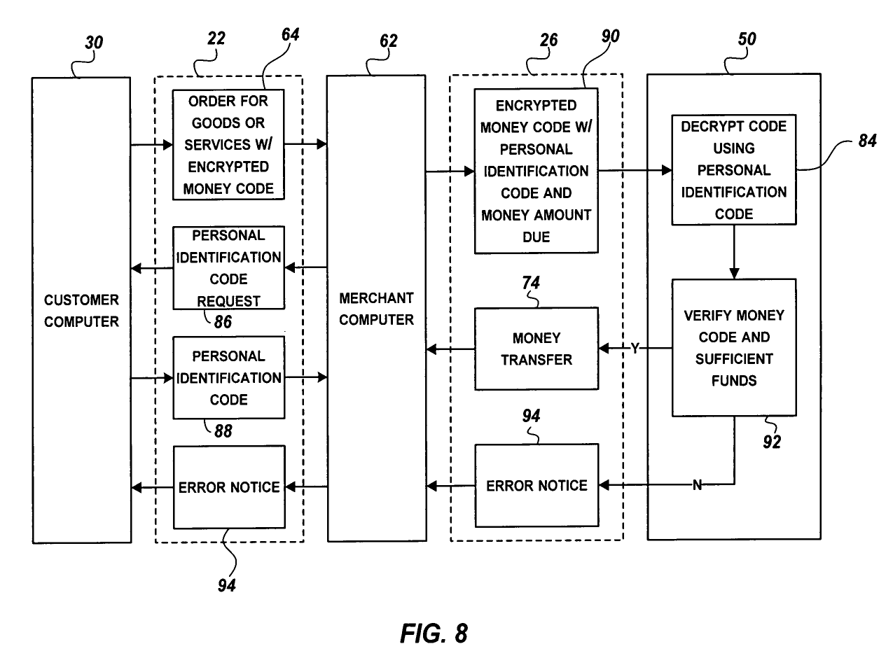

Another embodiment of the money code submission 22 and validation 26 processes utilizing the encrypted money code 56 is shown in FIG. 8. The customer 12 may submit the encrypted money code 56 along with the order 64 instead of the actual money code. Upon receipt of an order 64 and encrypted money code 56, software executing on the merchant computer 62 transmits over the communications system a request 86 for the personal identification code to the customer 12. The customer then submits the personal identification code 88 to the merchant computer 62. The merchant computer 62 transmits the received encrypted money code, personal identification code, and money amount due 90 to the financial institution computer 50 for validation 26. Software executing on the financial institution computer 50 receives the data 90 from the merchant computer 62 and decrypts 84 the encrypted money code 56 using the personal identification code 88. If the proper personal identification code was provided, the decrypted money code will match a stored money code and the financial institution can validate the money code to verify the availability of sufficient funds to cover the amount due submitted by the merchant 92. If the wrong personal identification code is provided, the money code will be improperly decrypted and result in an invalid money code. In this instance, or if insufficient funds are available, software executing on the financial institution computer 50 will transmit an appropriate error notice 94 over the communications system 28 to the merchant computer 62.

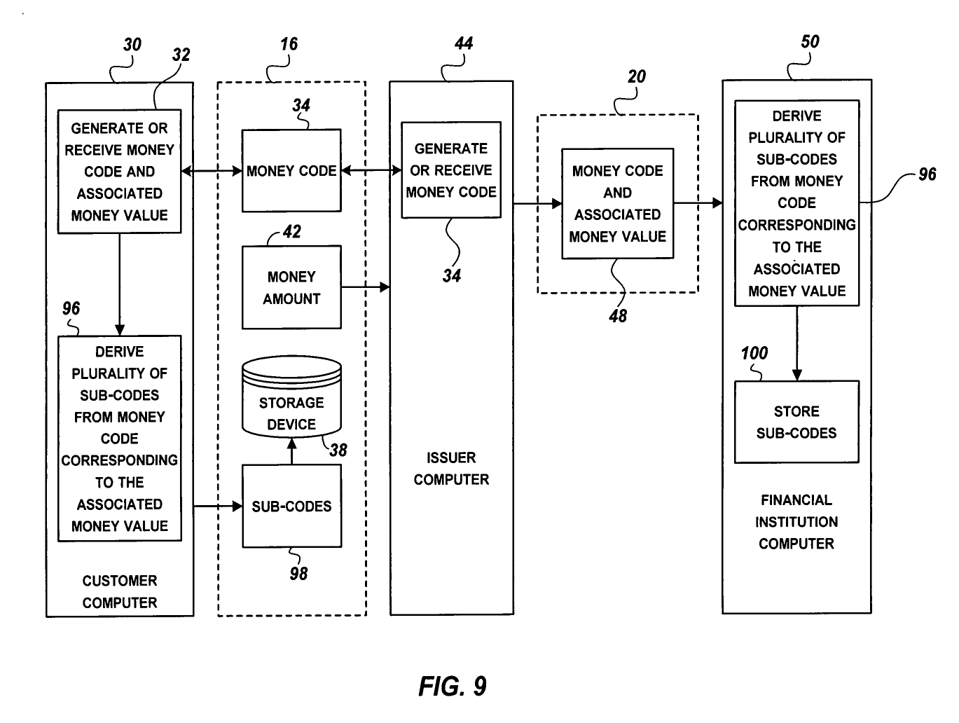

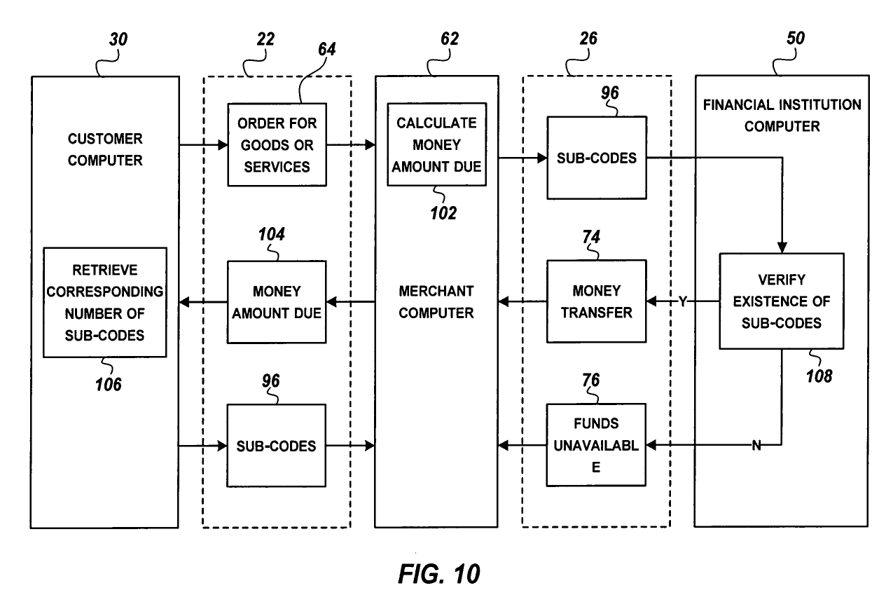

In another embodiment of the system as shown in FIGS. 9 and 10, a set of sub-codes can be derived from the money code 34 to further increase the security and anonymity of the system 10. In this embodiment, during the generation 16 and valuation 20 processes, shown in FIG. 9, software executing on both the customer computer 30 and financial institution computer 50 derives 96 a plurality of sub-codes 98 from the money code 34 corresponding to the money amount 42 presented by the customer 12 to the issuer 14. For example, if the customer 12 presented twenty dollars to the issuer 14, the software on both the customer and financial institution computers 30, 50 would derive twenty sub-codes 98 from the money code 34 and store 100 them appropriately. Thus, each sub-code 98 would represent a single dollar. It is to be understood that the sub-codes 98 could represent different units of money such as higher denominations of bills (i.e. tens or twenties) or coins (i.e. quarters or dimes) depending on the specificity desired in the system 10. It is only important that each of the sub-codes 98 represent the same unit of money. The derivation 96 of the sub-codes 98 can be readily accomplished by any suitable method, such as by using a one-way function or a cryptographic hash function.

Accordingly, during the submission 22 and validation 26 processes, shown in FIG. 10, software executing on the merchant computer 62 would calculate 102 and transmit the money amount due 104 to the customer computer 30 following submission of an order 64 from the customer 12. Software executing on the customer computer 30 would retrieve 106 and transmit the necessary amount of sub-codes 98 to the merchant computer 62 corresponding to the amount due 104. For example, if sixteen dollars were the amount due 104, sixteen sub-codes 98 that had been derived from the money code 34 would be retrieved 106 from the storage device and transferred to the merchant computer 62 over the communications link. Upon receipt, the merchant computer 62 would transfer the sub-codes 98 to the financial institution 18 for validation 26. Software executing on the financial institution computer 50 would validate 26 the sub-codes 98, for example by verifying 108 that the numbers existed or had not been previously spent. It is understood that that this embodiment can also incorporate the personal identification code and encryption features described above to further increase the security of the system.

While the above embodiments refer to the transactions between the customer 12 and merchant 24 as being by way of computer, it is also recognized that the customer 12 may use the money code 34 at any merchant's establishment having the means to recognize and process the money code 34. In such instances, the merchant's computer 54 would function essentially the same as above. Upon entry of the money code 34 into the merchant's computer 54, software executing on the computer 54 would transmit the money code and amount due 58 to the financial institution's computer 50 to ensure sufficient funds are available.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for anonymously purchasing goods and services over the Internet comprising:
a money code containing no identification data related to a customer and being untraceable to the customer;
a money amount received from the customer and associated with said money code and input into an issuer computer such that said money code has an associated money value based on the money amount received from the customer;
said money code and associated money value transmitted to a financial institution computer for storage thereon;
an order generated on the customer computer;
said order and said money code transmitted to a merchant computer;
a query generated by the merchant computer, said query determining a money amount due for said order and transmitting said money code and money amount due to the financial institution computer;
said money code and money amount due received by the financial institution computer, the money amount due compared to the associated money value stored on the financial institution computer; and
a notification notifying said merchant computer of fund availability.

2. The system of claim 1 wherein said money code is generated by the client computer.

3. The system of claim 2 further comprising a personal identification code associated with said money code for controlling access and use of said money code.

4. The system of claim 3 wherein said money code is encrypted based on said personal identification code for storage on the customer computer.

5. The system of claim 4 wherein the customer computer requests said personal identification code from the customer and upon receipt of the personal identification code, retrieves and decrypts said money code prior to transmission to the merchant computer.

6. The system of claim 4 further comprising:
a request sent by the merchant computer for requesting said personal identification code from the customer upon receipt of said order and money code;
said personal identification code sent to the merchant computer in response to said request;
said personal identification code, said money code the money amount due transmitted to the financial institution computer;
said personal identification code, said money code the money amount due received by the financial institution computer; and
said money code decrypted using said personal identification code prior to determining fund availability.

7. The system of claim 1 wherein said money code is generated by the issuer computer.

8. The system of claim 1 wherein an Internet website is operated and maintained on the merchant computer, and is accessible by the customer for facilitating commercial transactions between the customer and a merchant.
